(19) United States
(12) Patent Application Publication
(10) Pub. No.: US 2007/0095196 A1
(43) Pub. Date: May 3, 2007

(54) Scale practice device

(76) Inventors: Shigeki Yagi, Chiba-shi (JP); Keori Takano, Chiba-shi (JP)

Correspondence Address: BRUCE L. ADAMS, ESQ., SUITE 1231, 17 BATTERY PLACE, NEW YORK, NY, 10004, US

(21) Appl. No.: 11/586,400

(22) Filed: Oct. 25, 2006

(30) Foreign Application Priority Data
Nov. 2, 2005 (JP) 2005-319000

(51) Int. Cl. G10H 7/00

(52) U.S. Cl. 84/612

(57) ABSTRACT

Provided is a small scale practice device, which is capable of displaying tuning results that are exact and highly-responsive and information on a tempo with good visibility, and being attached to a musical instrument. A scale practice device is fixed to a musical instrument, a tone generated by the musical instrument is collected as a mechanical vibration, and tuning results are calculated. The way of light emission of a plurality of light-emitting elements in a light-emitting element group in the scale practice device is controlled, whereby a tempo and tuning results are expressed so that a player can recognize the tempo and the tuning results simultaneously with ease.

### BACKGROUND OF THE INVENTION

1. Field of the Invention

The present invention relates to a scale practice device supporting a musical instrument practice. More particularly, the present invention relates to a scale practice device having a tempo indicating function and a tuning function of a tone generated from a musical instrument.

2. Description of Related Art

Up to now, as an apparatus used in the case of performing a scale practice with a musical instrument, a metronome that is an apparatus indicating a constant tempo is known. Further, a tuner is known, which is an apparatus for measuring a deviation between a pitch of atone generated from a musical instrument and a reference frequency to be a standard, and includes display means for displaying the deviation.

There is also an apparatus in which a metronome function and a tuner function are integrated, and each function is selected to be used. Further, a method has been proposed, for displaying tuning results of a tone while generating a tempo sound of a metronome (refer to JP 2003-316354 A and JP 2004-333919 A).

In an apparatus in which a metronome function and a tuner function are integrated, when a tempo sound of a metronome is generated during turning of a tone, the tempo sound is also inputted to a microphone for inputting a sound to be tuned. Consequently, a noise is superimposed over a signal of a tone to be tuned, which adversely affects tuning results. Therefore, in JP 2003-316354 A and JP 2004-333919 A, the following method is considered. While a tempo sound is being generated (i.e., tone collection inhibiting period), an audio signal outputted from a microphone is removed, and while a tempo sound is not generated (i.e., tone collectable period), tuning processing is performed using an audio signal outputted from the microphone, and this result is displayed in simulation as tuning results of the tone collection inhibiting period.

However, according to the above-mentioned method, as the set tempo is faster, the ratio of the tone collectable period with respect to the tone collection inhibiting period becomes lower, and the exactness of the tuning results decreases. Further, when it is desired to know whether a tone is generated with an exact pitch as in a long tone practice, or when those apparatuses are used for the purpose of correcting a pitch shift at an attack (i.e., at a time of start of tone generation) in a scale practice, a timing at which tuning results are desired to be displayed may be overlapped with the tone collection inhibiting period, and hence, the purpose of use is not achieved. That is, the techniques described in JP 2003-316354 A and JP 2004-333919 A have a problem that tuning results which are exact and highly responsive with respect to a tone of a musical instrument cannot be displayed.

On the other hand, in the case of tuning a tone in general, in order to collect a tone exactly, an apparatus should be placed close to, preferably in contact with a musical instrument. In this case, it is necessary that the apparatus is small and lightweight so that the apparatus does not adversely affect practice of a musical instrument by a player.

Further, during a practice of a musical instrument, a player should concentrate on an instrument operation (i.e., playing) as much as possible. Thus, an apparatus needs to display tuning results and information on a tempo exactly and easily recognizable even when the player does not stare at the results and information consciously.

### SUMMARY OF THE INVENTION

In view of the above-mentioned problem, the invention of the present application provides a small scale practice device capable of simultaneously displaying tuning results that are exact and highly responsive and information on a tempo with good visibility, and being attached to a musical instrument.

In order to solve the above-mentioned problem, according to the present invention, there is provided a scale practice device, including: light-emission display means composed of a plurality of light-emitting elements placed in a row; tempo setting means for setting a tempo, and generating an indication signal indicating a generation of a tempo sound in accordance with the tempo and a display of the tempo; tempo display control means for generating tempo sound control information for controlling the generation of the tempo sound and tempo display control information for controlling the light emission of the light-emitting element of the light-emitting display means, based on the indication signal; tempo sound generating means for generating the tempo sound based on the tempo sound control information; vibration acquisition means for acquiring a tone generated by a musical instrument as a vibration, and converting the vibration into an electric signal; input signal amplification means for amplifying a waveform of the electric signal; waveform shaping means for shaping the waveform of the signal amplified by the input signal amplification means; deviation detection means for calculating a fundamental frequency of the tone based on the signal obtained by shaping the waveform by the waveform shaping means, and calculating a deviation between the fundamental frequency of the tone and a frequency of a reference sound as turning result; deviation display control means for generating deviation display control information for controlling the light emission of the light-emitting element of the light-emission display means, based on the deviation; and mediation means for obtaining the tempo display control information and the deviation display control information, and sending the tempo display control information and/or the deviation display control information to the light-emission display means, based on a predetermined condition, in which the light-emission display means displays the tempo and the deviation based on the information obtained from the mediation means.

Thus, the scale practice device of the present invention displays both the tempo and the deviation with the identical light-emission display means by mediating in information with the mediation means, so that a display space can be reduced, whereby the scale practice device can be downsized.

Further, the tempo display control means of the present invention is structured so as to generate tempo display control information for controlling the light emission of the light-emitting element of the light-emission display means, based on the indication signal, so as to display the tempo by causing light-emitting elements to sequentially emit light and sequentially extinguish light from one end to another end of the light-emission display means.

Further, in a case where the tempo display control information and the deviation display control information are not information for causing the same light-emitting element to emit light at the same timing, the mediation means of the present invention is structured so as to send the tempo display control information and the deviation display control information to the light-emitting display means, and in a case where the tempo display control information and the deviation display control information are information for causing the same light-emitting element to emit light at the same timing, the mediation means of the present invention is structured so as to send only the deviation display control information to the light-emission display means.

The tempo is continuously, regularly, and periodically displayed by the light-emission display means, and even if the omission of light emission occurs in one light-emitting element, an immediately adjacent light-emitting element emits light, so that the notification of the tempo to a player is hardly affected. Therefore, according to the present invention, in the case where the display of the tempo and the deviation is a display of causing the same light-emitting element to emit light, the display of the deviation is prioritized, whereby both the tempo and the deviation can be displayed simultaneously so as to be easily identifiable without impairing the response of the deviation with respect to a tone.

Further, in a case where the tempo display control information and the deviation display control information are information for causing the same light-emitting element to emit light at the same timing, and in a case where a light-emitting element to emit light is placed at one of ends of a row of the light-emission display means, the mediation means of the present invention is structured so as to send only the tempo display control information to the light-emission display means.

The timing of the light emission of a light-emitting element placed at a right end or a left end of the light-emission display means is frequently matched with the timing at which tempo sound generating means generates a click sound. Therefore, according to the present invention, by causing a light-emitting element at the right end or the left end of the light-emission display means to emit light with a tempo prioritized, while displaying tuning results, a player can recognize the tempo exactly.

Further, the tempo display control means of the present invention is structured so as to generate tempo display control information for controlling the light emission of the light-emitting element of the light-emission display means based on the indication signal so as to display the tempo by causing light-emitting elements at the both ends of the light-emission display means to emit light and extinguish light alternately.

Further, in a case where the tempo display control information and the deviation display control information are not information for causing the same light-emitting element to emit light at the same timing, the mediation means of the present invention is structured so as to send the tempo display control information and the deviation display control information to the light-emission display means, and in a case where the tempo display control information and the deviation display control information are information for causing the same light-emitting element to emit light at the same timing, the mediation means of the present invention is structured so as to send only the tempo display control information to the light-emission display means.

According to the above-mentioned structure, even in the case of showing a tempo with only light-emitting elements placed at the right end and the left end of the light-emission display means, the tempo and the tuning results can be displayed so as to be recognized simultaneously.

Further, in a case where the deviation display control information is information for causing a light-emitting element at one of the ends of the light-emission display means to emit light, the mediation means of the present invention is structured so as to stop sending the deviation display control information to the light-emission display means.

According to the above-mentioned structure, light-emitting elements showing a tempo and light-emitting elements showing tuning results can be clearly distinguished in the light-emission display means, so that the tempo and the tuning results can be displayed simultaneously so as to be recognized more easily.

Further, the light-emitting element of the light-emission display means of the present invention is structured so as to be capable of emitting light of multi-color, and displays the tempo and the deviation with different colors. Further, the light-emitting element of the light-emission display means of the present invention is structured so as to be capable of controlling the brightness, and displays the tempo and the deviation with different brightness.

According to the structure, due to the difference in the emission color and the brightness of light-emitting elements of the light-emission display means, the tempo and the deviation can be displayed so as to be recognized more easily.

Further, the scale practice device of the present invention is structured so as to further include instrument attachment means for fixing a body of the scale practice device to the musical instrument, in which the vibration acquisition means acquires a vibration generated when the musical instrument generates a tone from the musical instrument via the musical instrument attachment means.

According to the above-mentioned structure, the mechanical vibration of a musical instrument while the musical instrument is generating a tone can be obtained with an extremely high S/N ratio, and the deviation between the tone and the reference sound can be calculated with high accuracy. The scale practice device of the present invention is downsized as described above, so that the scale practice device can be attached to a musical instrument without any problem, and does not affect playing.

Further, according to a present invention, there is provided a scale practice device for supporting a scale practice of a musical instrument, including: instrument attachment means for fixing the scale practice device to the musical instrument; light-emission display means composed of a plurality of light-emitting elements placed in a row; tempo setting means for setting a tempo, and generating an indication signal indicating a generation of a tempo sound in accordance with the tempo and a display of the tempo; tempo display control means for generating tempo sound control information for controlling the generation of the tempo sound and tempo display control information for controlling the light emission of the light-emitting element of the light-emission display means, based on the indication signal; tempo sound generating means for generating a tempo sound based on the tempo sound control information; vibration acquisition means for acquiring a tone generated by a musical instrument as a vibration from the musical instrument via the musical instrument attachment means, and converting the vibration into an electric signal; input signal amplification means for amplifying a waveform of the electric signal; waveform shaping means for shaping a waveform of a signal amplified by the input signal amplification means; deviation detection means for calculating a fundamental frequency of the tone based on the signal with the waveform shaped by the waveform shaping means, and calculating a deviation between the fundamental frequency of the tone and a frequency of a reference sound; and deviation display control means for generating deviation display control information for controlling the light emission of the light-emitting element of the light-emission display means, based on the deviation, in which the light-emission display means obtains the tempo display control information and/or the deviation display control information, and displays the tempo and/or the deviation.

Further, the tempo display control means of the present invention is structured so as to generate tempo display control information for controlling the light emission of the light-emitting element of the light-emission display means, based on the indication signal, so as to display the tempo by causing light-emitting elements to sequentially emit light and sequentially extinguish light from one end to another end of the light-emission display means.

Further, the tempo display control means of the present invention is structured so as to generate tempo display control information for controlling the light emission of the light-emitting element of the light-emission display means based on the indication signal so as to display the tempo by causing at least one particular light-emitting element of the light-emission display means to emit light and extinguish light, and the deviation display control means of the present invention is structured so as to generate deviation display control information for controlling the light emission of the light-emitting element based on the deviation so as to display the deviation, using a light-emitting element other than the at least one particular light-emitting element of the light-emission display means. Preferably, the at least one particular light-emitting element is placed at both ends of the light-emission display means.

According to the above-mentioned structure, light-emitting elements showing a tempo and light-emitting elements showing tuning results can be clearly distinguished in the light-emission display means, so that the tempo and the tuning results can be displayed simultaneously so as to be recognized more easily.

Due to taking the above mentioned means, a small scale practice device can be provided, which is capable of displaying tuning results (i.e., a deviation between a fundamental frequency of a tone and a frequency of a reference sound) that are exact and highly responsive and information on a tempo with good visibility, and being attached to a musical instrument.

The scale practice device of the present invention is attached directly to a musical instrument with a musical instrument attachment portion such as a clip, whereby a specific vibration when a tone is generated by a musical instrument can be exactly detected. Therefore, exact tuning with high response can be performed with almost no effect by the generation of a tempo sound from a speaker or the like built into a scale practice device body.

Further, the scale practice device of the present invention displays a tempo using a light-emitting element group composed of a plurality of light-emitting elements and displays tuning results using the same light-emitting element group. Therefore, the visibility of the display is satisfactory even in a dark place and a display space can be saved. Thus, a compact scale practice device attachable to a musical instrument with good portability can be provided.

In particular, the scale practice device of the present invention can simultaneously display a tempo and tuning results so that the tempo and the tuning results can be respectively recognized with ease, using the light-emitting element group. Therefore, it is considered that the scale practice device of the present invention is an most suitable apparatus that supports a scale practice in which a tone at a constant pitch is generated in time with a constant tempo sound or the like.

### BRIEF DESCRIPTION OF THE DRAWINGS

In the accompanying drawings:

FIG. 1 is a schematic view of an outer appearance of a scale practice device of the present invention;

FIG. 2 shows an example in which a scale practice device 1 is attached to a musical instrument;

FIG. 3 is a schematic view of a hardware structure of the scale practice device 1;

FIG. 4 is a functional block diagram of the scale practice device 1;

FIGS. 5A and 5B show a light-emission method of a light-emitting element group 17 in a metronome mode;

FIG. 6 is a functional block diagram of the scale practice device 1;

FIG. 7 is a flow chart showing a flow of the operation of mediation means 61 of Embodiment 2;

FIG. 8 schematically shows a light-emission method of the light-emitting element group 17 in a simultaneous mode of Embodiment 2;

FIG. 9 is a flowchart showing a flow of the operation of the mediation means 61 of Embodiment 3;

FIG. 10 schematically shows a light-emission method of the light-emitting element group 17in a simultaneous mode of Embodiment 2;

FIG. 11 is a flowchart showing a flow of the operation of the mediation means 61 of Embodiment 4;

FIG. 12 schematically shows a light-emission method of the light-emitting element group 17 in a simultaneous mode of Embodiment 4;

FIG. 13 is a flowchart showing a flow of the operation of the mediation means 61 of Embodiment 5; and

FIG. 14 schematically shows a light-emission method of the light-emitting element group 17 in a simultaneous mode of Embodiment 5.

### DETAILED DESCRIPTION OF THE PREFERRED EMBODIMENTS

Hereinafter, the present invention will be described by way of embodiments with reference to the drawings. Components similar in terms of configuration are denoted by the same reference numerals.

Embodiment 1

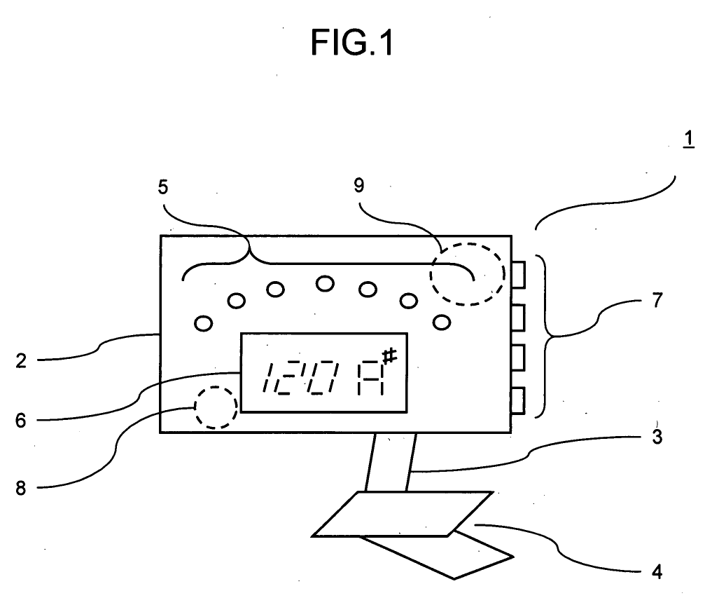

As Embodiment 1 of the present invention, the basic operation of a scale practice device having both a metronome mode and a tuning mode will be described. FIG. 1 is a schematic view of an outer appearance of the scale practice device of the present invention. In FIG. 1, reference numerals 1, 2, 3, 4, 5, 6, 7, 8, and 9 denote a scale practice device, a scale practice device body, an arm portion, a musical instrument attachment portion, a light-emitting element group, a display portion, an operating portion, a tone collecting portion, and a tempo sound generating portion, respectively.

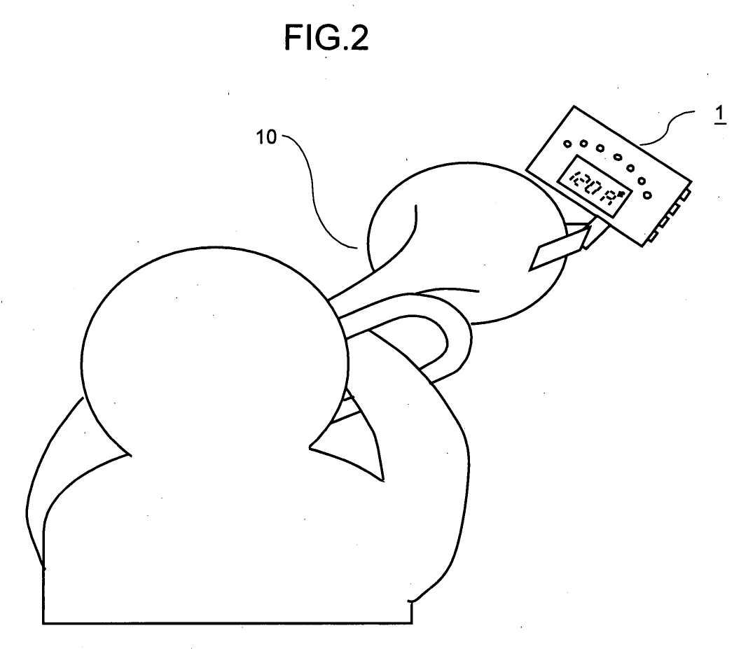

FIG. 2 shows an example in which the scale practice device 1 is attached to a musical instrument. The musical instrument attachment portion 4 has a shape such as a clip, and sandwiches a part of a musical instrument 10 (herein, a wind instrument) to fix the scale practice device 1 to the musical instrument 10. Then, the mechanical vibration generated when the musical instrument 10 generates a tone is transmitted to the arm portion 3. The shape of the musical instrument attachment portion 4 is not limited to a clip shape, as long as it fixes the scale practice device 1 to the musical instrument 10, and can transmit the mechanical vibration to the arm portion 3.

The arm portion 3 is placed between the body 2 and the musical instrument attachment portion 4, and although not shown, has a joint portion that can rotate to be fixed to a connecting portion with the body 2 and/or a connecting portion with the musical instrument attachment portion 4. A player can rotate the body 2 of the scale practice device 1 in various directions with respect to the musical instrument 10 due to the function of the joint portion, thereby fixing the scale practice device 1 in a position preferred by the player. The arm portion 3 transmits the vibration transmitted from the musical instrument attachment portion 4 to the body 2. The musical instrument attachment means in the scope of the claims of the present invention corresponds to the musical instrument attachment portion 4 and the arm portion 3.

The light-emitting element group 5 has a configuration in which a plurality of light-emitting elements is arranged in a row. In the case where the attachment of the scale practice device 1 to the musical instrument 10 is considered, it is desirable that the number of light-emitting elements included in the light-emitting element group 5 is set to be a minimum required number, whereby space-saving and reduction in power consumption are realized. Further, in the case where the visibility of a display is considered, if the number of light-emitting elements becomes large, the kind and contents of the matter meant by the light emission be come more complicated. Thus, even in view of the visibility, it is desirable that the number of light-emitting elements is a minimum number. According to the present invention, each light-emitting element in the light-emitting element group 5 is selectively caused to emit light, whereby both of a tempo and/or tuning results are displayed. Therefore, it is not necessary to prepare a plurality of light-emitting element groups 5 (i.e., increase the number of display means), whereby space-saving, reduction in power consumption, improvement of visibility, and the like are realized.

As a light-emitting element, although a light-emitting diode (LED) is a typical example, a display body or the like using an electroluminescence (i.e., organic EL or inorganic EL) may be used.

The display portion 6 displays the information on a set tempo, the name of a pitch that is being tuned, and the like. According to the present invention, although a liquid crystal display (LCD) capable of displaying characters and the like is used, the present invention is not limited thereto. For example, an organic EL or an inorganic EL that is a light-emitting element can also be used.

The operating portion 7 includes an ON/OFF switch, an operation setting button related to a tempo display, tuning, and the like, a tempo value setting button, a volume adjusting button of a tempo sound, a beat setting button, a setting button for the name of a pitch to be tuned, and the like.

The tone collecting portion 8 has a function of collecting the mechanical vibration when the musical instrument 10 generates a tone via the musical instrument attachment portion 4 and the arm portion 3, and converting it into an electric signal. The tone collecting portion 8 is generally built in the body 2, and for example, a piezoelectric element is used as the tone collecting portion 8. However, the tone collecting portion 8 is not limited to the piezoelectric element as long as it is an element capable of detecting the vibration such as a gyrosensor.

The mechanical vibration when the musical instrument 10 generates a tone has a frequency spectrum specific to the musical instrument 10. However, when seen in a time domain, the mechanical vibration is observed as a waveform repeated with a predetermined period, so information related to a pitch of a tone sound generated by the musical instrument 10 can be obtained by analyzing this vibration.

The tempo sound generating portion 9 is a speaker or the like, and generates a tempo sound (click sound) in accordance with a set tempo value or a set beat.

As described above, the scale practice device 1 is fixed to the musical instrument 10, and exactly detects a specific vibration when the musical instrument 10 generates a tone. According to this method, a target tone can be collected with an S/N ratio much higher than that in the case where a tone is collected with a microphone. Therefore, even in the case where tuning is performed while a tempo sound is generated, a signal related to the tone can be obtained with almost no effect by the generation of a tempo sound from the tempo sound generating portion 9, and hence, exact tuning results with high response can be displayed.

Further, the scale practice device 1 displays a tempo and/or tuning results, using the same light-emitting element group 5. Therefore, the satisfactory visibility is provided even in a dark place, compared with that of the display means such as an LCD, and a display space is also saved. Thus, a compact and portable scale practice device that can be attached to the musical instrument 10, as shown in FIG. 2, can be provided.

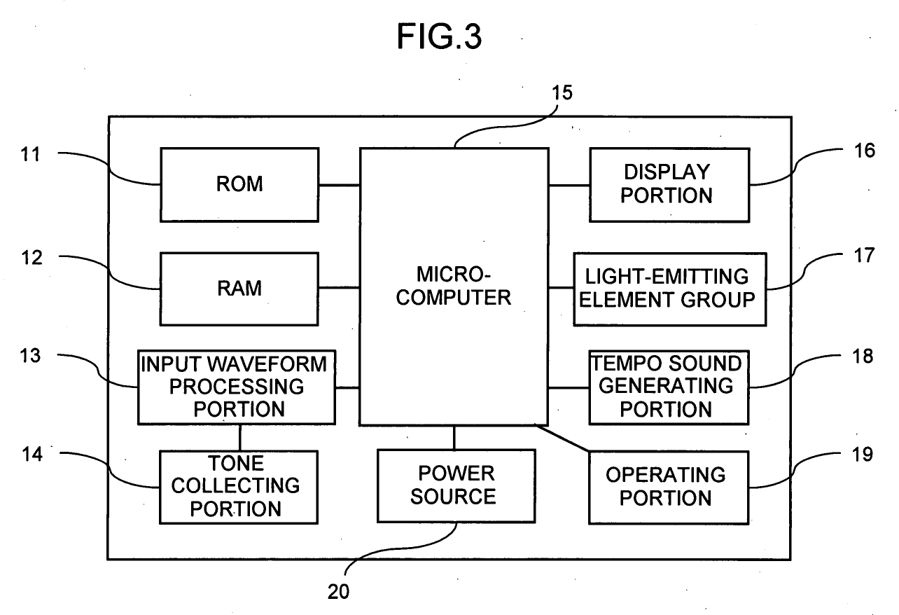

FIG. 3 is a schematic view of a hardware configuration of the scale practice device 1 of the present invention. Reference numerals 11, 12, 14, 13, 16, 17, 18, 19, 20, and 15 denote a ROM storing various kinds of operation programs and the like, a RAM mainly used as an operation region of various kinds of calculations, a tone collecting portion, an input waveform processing portion for amplifying the waveform of an electric signal outputted from the tone collecting portion 14, thereby shaping the waveform, a display portion, a light-emitting element group, a tempo sound generating portion, an operating portion, a power source made of a battery or the like, and a microcomputer for controlling the operation of the scale practice device 1, respectively.

The tone collecting portion 14, the display portion 16, the light-emitting element group 17, the tempo sound generating portion 18, and the operating portion 19 respectively correspond to the tone collecting portion 8, the display portion 6, the light-emitting element group 5, the tempo sound generating portion 9, and the operating portion 7 of FIG. 1.

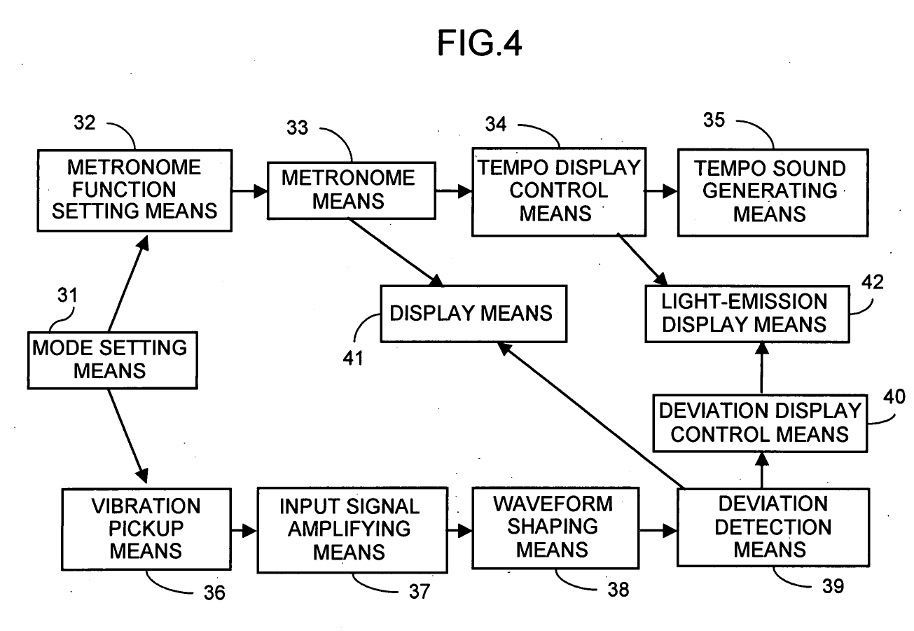

Next, the basic function of the scale practice device 1 of Embodiment 1 of the present invention will be described. FIG. 4 is a functional block diagram of the scale practice device 1. The scale practice device 1 of the present invention includes mode setting means 31, metronome function setting means 32, metronome means 33, tempo display control means 34, tempo sound generating means 35, vibration pickup means 36, input signal amplification means 37, waveform shaping means 38, deviation detection means 39, deviation display control means 40, display means 41, and light-emission display means 42. The functions of those means are achieved by reading and executing operation programs stored in the ROM 11 by the microcomputer 15, and controlling the operation of each hardware in the scale practice device 1 shown in FIG. 3. The tempo setting means in the scope of the claims of the present invention corresponds to the metronome function setting means 32 and the metronome means 33. Further, vibration acquisition means corresponds to the vibration pickup means 36.

The mode setting means 31 sets the operation mode of the scale practice device 1. The operation mode includes a metronome mode for indicating a tempo, a tuning mode for tuning a tone generated by the musical instrument 10, and the like. The operation mode is set based on an operation signal from the operating portion 7.

In the case where a metronome mode is set in the mode setting means 31, the metronome function setting means 32 operates. The metronome function setting means 32 actually indicates a tempo sound, and sets the value of a tempo to be generated based on the operation signal from the operating portion 19. The description will be made assuming that a tempo value “TEMPO=120 (120 (bpm))” is set with the operating portion 19.

The metronome means 33 sets a period at which the tempo sound is indicated, using the tempo value set in the metronome function setting means 32. Then, the metronome means 33 sends, an instruction to the tempo display control means 3-4 so that the light-emission display means 42 performs, a display of the tempo at that period, and the tempo sound generating portion 9 generates the tempo sound at that period. Further, the light-emission display means 42 sends information on the tempo value to be displayed to the display means 41.

The tempo display control means 34 obtains an instruction on the display of the tempo and the generation of the tempo sound from the metronome means 33. Then, the tempo display control means 34 generates tempo sound control information for generating a tempo sound in accordance with the instruction, and sends it to the tempo sound generating means 35. Further, the tempo display control means 34 generates light-emission control information A (i.e., tempo display control information) for causing a particular light-emitting element to emit light during a particular period at a particular timing, and sends the light-emission control information A to the light-emission display means 42. In Embodiment 1, the tempo display control means 34 generates the light-emission control information A so as to display the tempo by causing light-emitting elements to emit light sequentially and extinguish light sequentially from one end to the other end of the light-emitting element group 17.

The display means 41 obtains information on the tempo value from the metronome means 33. Then, the display means 41 uses the information to display information on the tempo value. In the case where the tempo value is 120 (bpm), the display portion 18 displays “120”.

The tempo sound generating means 35 generates a tempo sound based on the tempo sound control information obtained from the tempo display control means 34. In the case where the set tempo value is 120 (bpm), a period of one beat is 0.5 seconds, so the tempo sound generating portion 9 generates a click sound every 0.5 seconds.

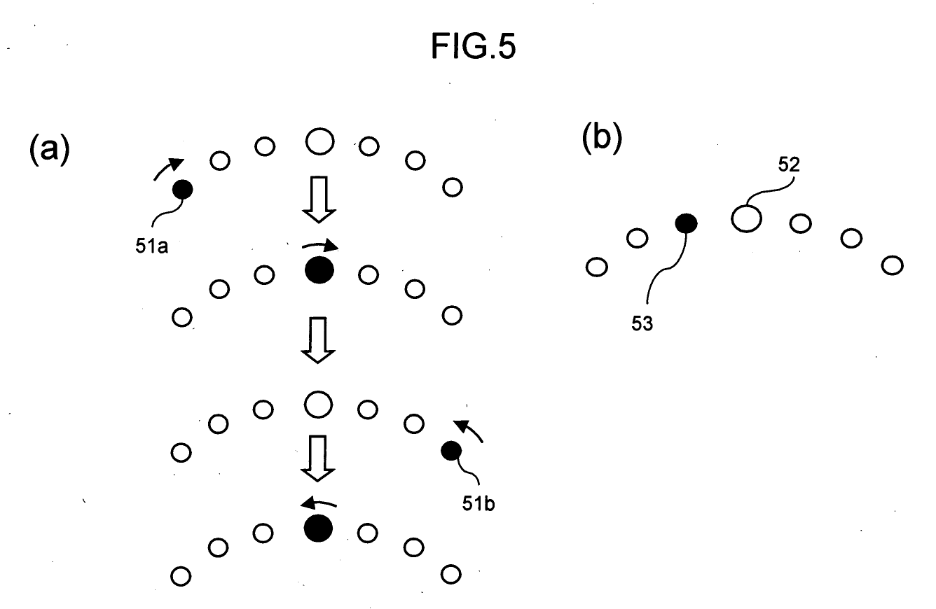

The light-emission display means 42 causes a particular light-emitting element of the light-emitting element group 17 to emit light during a particular period at a particular timing, based on the light-emission control information A obtained from the tempo display control means 34. An exemplary method of causing a light-emitting element of the light-emitting element group 17 to emit light will be described with reference to FIG. 5A.

FIG. 5A schematically shows a light-emission method of the light-emitting element group 17 in a metronome mode. In the figure, 7 light-emitting elements are arranged in a row as the light-emitting element group 17. One beat in a tempo is expressed by causing light-emitting elements to emit light continuously from a light-emitting element at one end to a light-emitting element at the other end.

For example, in the case where the light emission is started from the light-emitting element 51a, the light-emitting element 51a emits light during a period obtained by dividing the period (0.5 seconds in the case where the tempo value is 120 (bpm)) of one beat by 6, and a light-emitting element on the right side of the light-emitting element 51a emits light, simultaneously with the extinction of the light-emitting element 51a. The light-emitting element emits light during the same period and a light-emitting element on the right side thereof emits light simultaneously with the extinction of the light-emitting element. This is repeated, and a light-emitting element on the left side of a light-emitting element 51b at the right end emits light during the same period, and extinguishes light, whereby the display of a first beat is completed. Simultaneously with this, the light-emitting element 51b emits light, whereby the display of a second beat is started. In the display of the second beat, light-emitting elements emit light and extinguish light from the light-emitting element 51b at the right end to the light-emitting element 51a at the left end in this order. The light-emitting element group 17 expresses a tempo by repeatedly conducting such the light-emission method.

On the other hand, in the case where a tuning mode is set in the mode setting means 31, the vibration pickup means 36 operates. The vibration pickup means 36 collects the mechanical vibration while the musical instrument 10 is generating a tone, using the tone collecting portion 14. The vibration is converted into an, electric signal and sent to the input signal amplification means 37.

The input signal amplification means 37 amplifies the electric signal obtained from the vibration pickup means 36, using the input waveform processing portion 13, and sends it to the waveform shaping means 38.

The waveform shaping means 38 shapes the amplified electric signal obtained from the input signal amplification means 37, using the input waveform processing portion 13, and sends it to the deviation detection means 39.

The deviation detection means 39 obtains the shaped signal from the waveform shaping means 38, and calculates a fundamental frequency of the tone. Then, a table of tone names and frequencies of reference sounds previously stored in the ROM 11 or the RAM 12 are read, and a reference sound having a frequency closest to the fundamental frequency of the tone calculated previously is selected. Then, the frequency of the selected reference sound is compared with the calculated fundamental frequency of the tone to calculate a deviation.

The name of a tone to be tuned can also be previously set, using the operating portion 19. In this case, the deviation detection means 39 reads the frequency of a reference sound of the set tone name, and compares the read frequency with the calculated fundamental frequency of a tone to calculate a deviation.

The deviation display control means 40 obtains information on the deviation from the deviation detection means 39. Then, the deviation display control means 40 generates light-emission control information B (i.e., deviation display control information) for causing a particular light-emitting element to emit light, based on the information on the deviation, and sends it to the light-emission display means 42. In Embodiment 1, the light-emission control information B is generated so that, in the case where the deviation is zero (i.e., the fundamental frequency of the tone is matched with the frequency of the reference sound), a predetermined light-emitting element. (usually, a light-emitting element placed at the center of the light-emitting element group 17) of the light-emitting element group 17 is caused to emit light, and a light-emitting element farther from the predetermined light emitting element is caused to emit light as the absolute value of the deviation increases, whereby the deviation is displayed.

The display means 41 obtains information on the tone name and the deviation from the deviation detection means 39. Then, the information on the tone name is displayed using those pieces of information. For example, in the case where the tone name is A#, “A#” is displayed in the display portion 18.

The light-emission display means 42 causes a particular light-emitting element of the light-emitting element group 17 to emit light, based on the light-emission control information B obtained from the deviation display control means 40. An exemplary method of causing a light-emitting element of the light-emitting element group 17 to emit light will be described with reference to FIG. 5B.

FIG. 5B schematically shows a light-emission method of the liqht-emitting element group 17 in a tuning mode. Seven light-emitting elements are arranged in a row, since the same light-emitting element group 17 as that in the case of a metronome mode is used.

Alight-emitting element 52 at the center of the light-emitting element group 17 emits light in the case where the deviation is zero. As the deviation between the fundamental frequency of the tone and the frequency of the reference sound increases, a light-emitting element farther from the light-emitting element 52 emits light. For example, in the case where the fundamental frequency of the tone is higher than the frequency of the reference sound, a light-emitting element on the right side of the light-emitting element 52 emits light. In the case where the fundamental frequency of the tone is lower than the frequency of the reference sound, a light-emitting element on the left side of the light-emitting element 52 emits light. The figure shows that the tone with the fundamental frequency lower than the frequency of the reference sound is generated since a light-emitting element 53 emits light. The light-emitting element group 17 expresses the deviation as tuning results by conducting such the light-emission method.

Embodiment 2

As Embodiment 2 of the present invention, the basic operation of the scale practice device having a mode (simultaneous mode) for performing a metronome mode and a tuning mode simultaneously will be described. An outer appearance of the scale practice device 1, an exemplary attachment thereof to a musical instrument, and a hardware configuration are the same as those described in Embodiment 1, so the description thereof will be omitted.

The scale practice device 1 of the present invention adopts a procedure of collecting a mechanical vibration when the musical instrument 10 is generating a tone, as described in Embodiment 1. Therefore, even if the metronome mode and the tuning mode are performed simultaneously, tuning results that are exact and highly responsive can be displayed without being affected by a tempo sound.

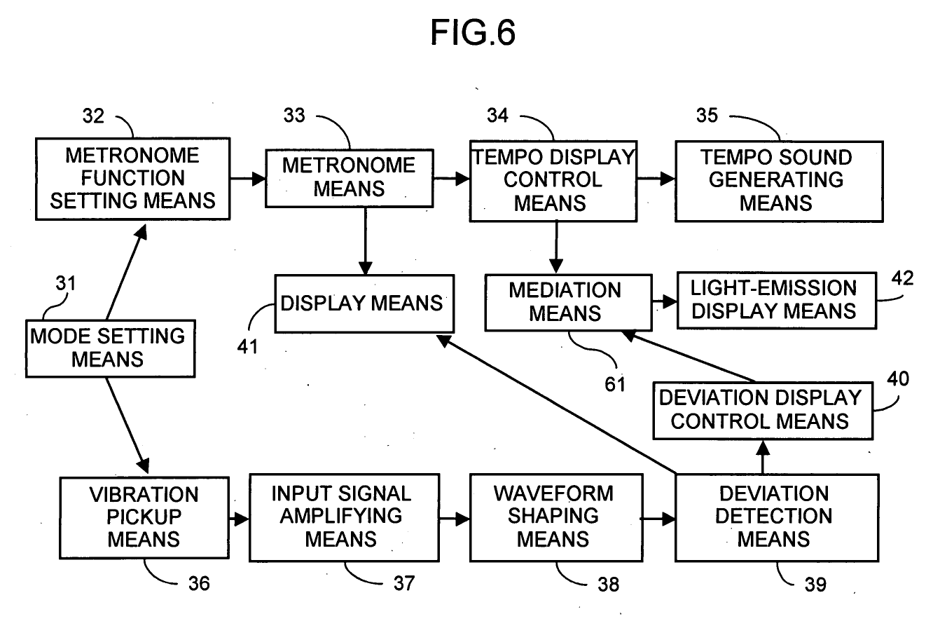

Next, the basic function of the scale practice device 1 of Embodiment 2 of the present invention will be described with reference to FIG. 6. FIG. 6 is a functional block diagram of the scale practice device 1. Mode setting means 31, metronome function setting means 32, metronome means 33, tempo display control means 34, tempo sound generating means 35, vibration pickup means 36, input signal amplification means 37, waveform shaping means 38, deviation detection means 39, deviation display control means 40, display means 41, and light-emission display means 42 and the same means as those described in Embodiment 1, so specific description of functions thereof will be omitted.

Embodiment 2 is an example in which the simultaneous mode is set in the mode setting means 31, and both the metronome mode and the tuning mode function simultaneously. That is, when a tone sound is generated by the musical instrument 10 under the condition that the tempo sound generating means 35 generates a tempo sound, and the light-emission display means 42 displays a tempo, the light-emission display means 42 displays tuning results while continuing to display the tempo. The mediation means 61 mediates the light-emission control information A and B, so that the light-emission display means 42 identifiably displays the tempo and the tuning results simultaneously with good visibility.

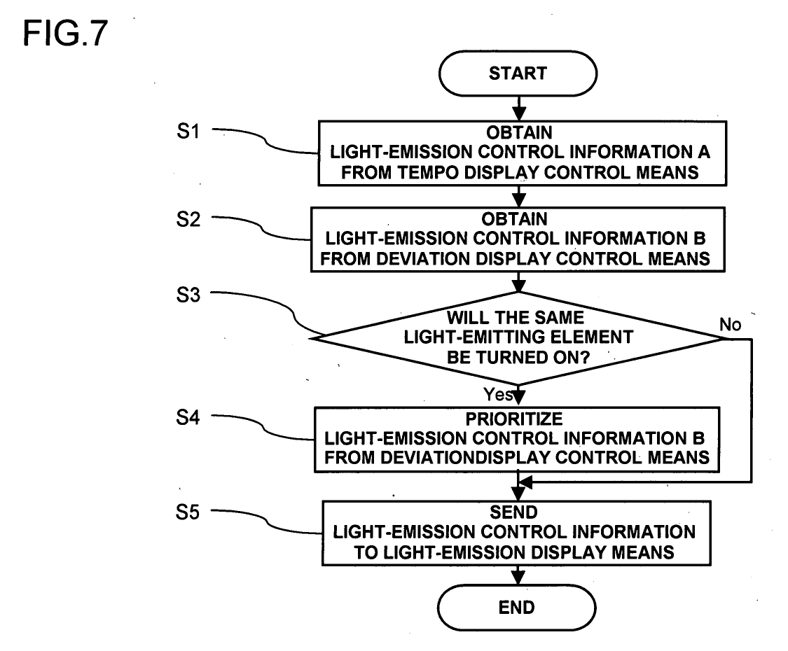

The mediation means 61 obtains the light-emission control information A expressing a tempo from the tempo display control means 34, and obtains the light-emission control information B expressing a deviation from the deviation display control means 40. Then, the mediation means 61 determines the light-emission control information to be actually sent to the light-emission display means 42, based on the light-emission control information A and B. The operation of the mediation means 61 will be described with reference to FIG. 7.

FIG. 7 is a flow chart showing a flow of the operation of the mediation means 61. First, the mediation means 61 obtains the light-emission control information A for displaying a tempo from the tempo display control means 34 (S1). The light-emission control information A includes identification information of a light-emitting element to emit light, information on a light-emission timing and a light-emission period, and the like.

Next, the light-emission control information B for displaying tuning results is obtained from the deviation display control means 40 (S2). The light-emission control information B also includes identification information on a light-emitting element to emit light, information on a light-emission timing and a light-emission period, and the like.

Next, it is confirmed whether or not the same light-emitting element should be caused to emit light at the same timing, based on the obtained light-emission control information A and B.

In the case where the same light-emitting element is not caused to emit light at the same timing (No in S3), the light-emission control information A and B is sent to the light-emission display means 42 as light-emission control information from the mediation means 61 (S5), and the operation of the mediation means 61 is completed.

In the case where the same light-emitting element is caused to emit light at the same timing (Yes in S3), in order to display the tuning results represented by the light-emission control information B preferentially, the light-emission control information A is deleted (S4). The prioritized light-emission control information B is sent from the mediation means 61 to the light-emission display means 42 as the light-emission control information (S5), and the operation of the mediation means 61 is completed.

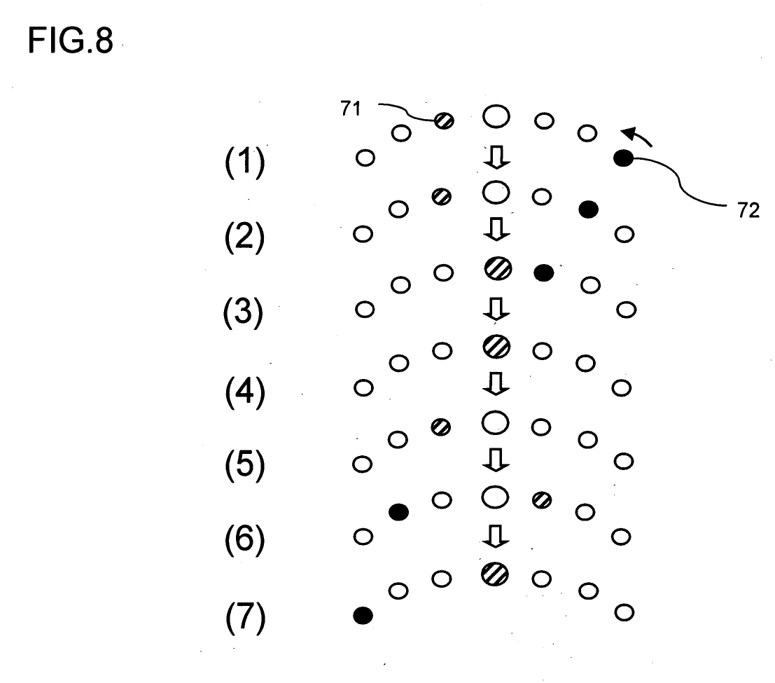

An example in which a light-emitting element of the light-emitting element group 17 emits light based on the light-emission control information sent from the mediation means 61 to the light-emission display means 42 will be described with reference to FIG. 8.

FIG. 8 schematically shows a light-emission method of the light-emitting element group 17 in the simultaneous mode. States of (1) to (7) show a change in a light-emission state with the passage of time of the light-emitting element group 17. Shaded circles denoted by reference numeral 71 are light-emitting elements showing tuning results, and black circles denoted by reference numeral 72 are light-emitting elements showing a tempo. The light-emitting elements 71 and 72 may have the same color and the same brightness. The light-emitting elements 71 and 72 may also emit light with different colors, or may emit light with different brightness. The light-emission method,of a tempo and tuning results is basically the same as that described in Embodiment 1.

The light-emitting element 72 showing a tempo shifts to the left side with the passage of time. At this time, the light-emitting element 72 showing a tempo and the light-emitting element 71 showing tuning results may cause the same light-emitting element to emit light. This case corresponds to states of (4) and (5), and a light-emitting element showing tuning results is preferentially caused to emit light, as described referring to FIG. 7.

The display of a tempo is continuously performed by the light-emitting element group 17, which is a regular, periodic, and continuous display. Even if the omission of light emission occurs sometimes in one light-emitting element, an immediately adjacent light-emitting element emits light, so the notification of a tempo to a player is hardly affected.

Thus, the scale practice device 1 of Embodiment 2 can simultaneously display a tempo and tuning results to a player in such a manner that the player can easily identify each information, due to the mediation of the light-emission control information A and B by the mediation means.

Embodiment 3

As Embodiment 3 of the present invention, another operation of the scale practice device having a mode (simultaneous mode) for performing both a metronome mode and a tuning mode simultaneously will be described. An outer appearance, an exemplary attachment to a musical instrument, and a hardware configuration of the scale practice device 1 are the same as those described in Embodiment 1, so the description thereof will be omitted. Further, the basic functions are the same as that described in Embodiment 2, excluding the mediation means 61, so the detailed description thereof will be omitted.

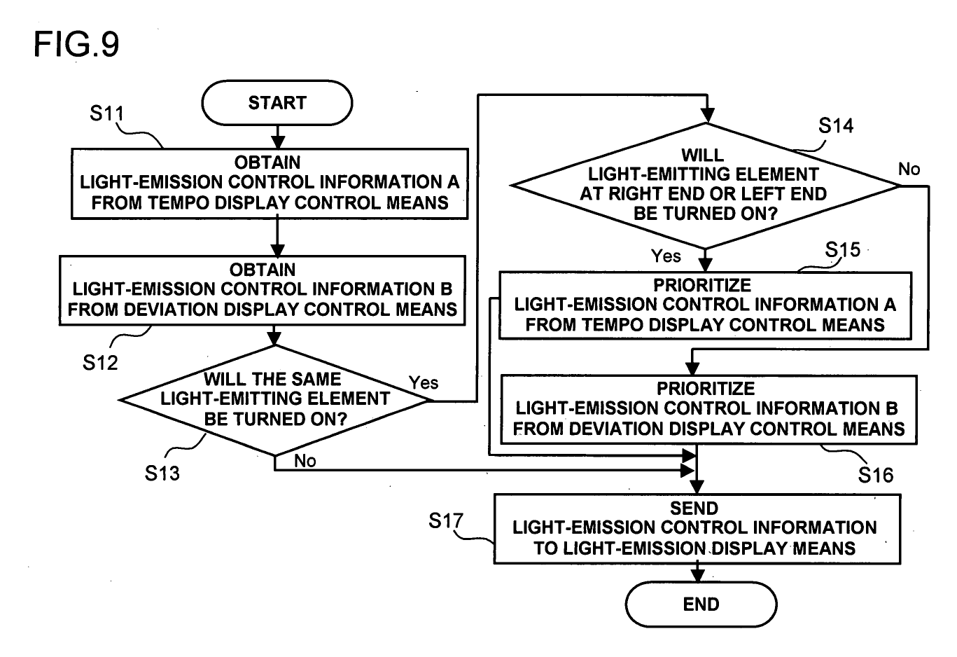

FIG. 9 is a flow chart showing a flow of the operation of the mediation means 61. First, the mediation means 61 obtains the light-emission control information A for displaying a tempo from the tempo display control means 34 (S11). The light-emission control information A includes identification information of a light-emitting element to emit light, information on a light-emission timing and a light-emission period, and the like.

Next, the light-emission control information B for displaying tuning results is obtained from the deviation display control means 40 (S12). The light-emission control information B also includes identification information on a light-emitting element to emit light, information on a light-emission timing and a light-emission period, and the like.

Next, it is confirmed whether or not the same light-emitting element should be caused to emit light at the same timing, based on the obtained light-emission control information A and B (S13) In the case where the same light-emitting element is not caused to emit light at the same timing (No in S13), the light-emission control information A and B is sent to the light-emission display means 42 as light-emission control information from the mediation means 61 (S17), and the operation of the mediation means 61 is completed.

In the case where the same light-emitting element is caused to emit light at the same timing (Yes in S13), it is confirmed whether a light-emitting element to emit light is the one at the right end or the left end of the light-emitting element group 17 (S14).

In the case where the light-emitting element to emit light is not the one at the right end or the left end (No in S14), in order to display the tuning results represented by the light-emission control information B preferentially, the light-emission control information A is deleted (S16). Then, the prioritized light-emission control information B is sent to the light-emission display means 42 as the light-emission control information from the mediation means 61 (S17), and the operation of the mediation means 61 is completed.

In the case where the light-emitting element to emit light is the one at the right end or the left end (Yes in S14), in order to display the tempo represented by the light-emission control information A preferentially, the light-emission control information B is deleted (S15). Then, the prioritized light-emission control information A is sent to the light-emission display means 42 as the light-emission control information from the mediation means 61 (S17), and the operation of the mediation means 61 is completed.

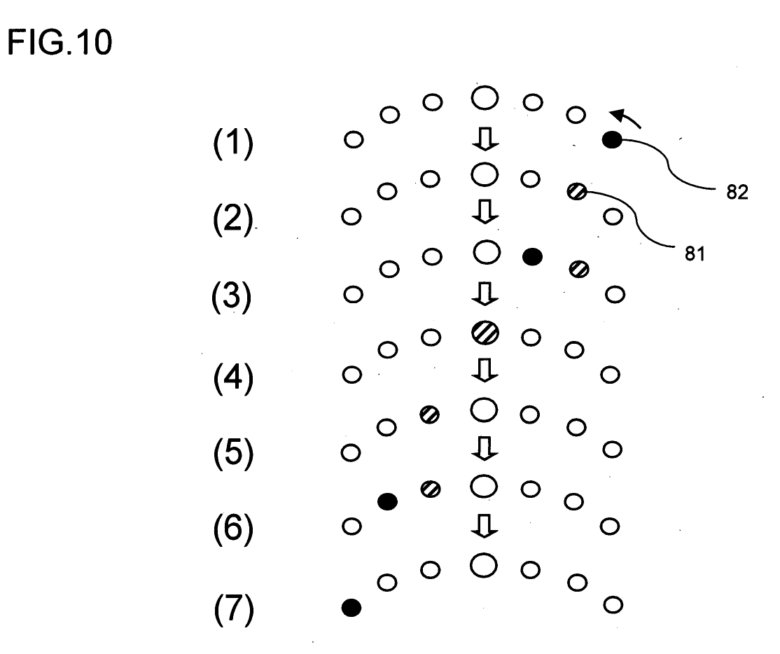

An example in which a light-emitting element of the light-emitting element group 17 emits light based on the light-emission control information sent from the mediation means 61 to the light-emission display means 42 will be described with reference to FIG. 10.

FIG. 10 schematically shows a light-emission method of the light-emitting element group 17 in the simultaneous mode. The states of (1) to (7) show a change in a light-emission state with the passage of time of the light-emitting element group 17. Shaded circles denoted by reference numeral 81 are light-emitting elements showing tuning results, and black circles denoted by reference numeral 82 are light-emitting elements showing a tempo. The light-emitting elements 81 and 82 may have the same color and the same brightness. The light-emitting elements 81 and 82 may also emit light with different colors, or may emit light with different brightness. The light-emission method of a tempo and tuning results is basically the same as that described in Embodiment 1.

The light-emitting element 82 showing a tempo shifts to the left side with the passage of time. At this time, the light-emitting element 82 showing a tempo and the light-emitting element 81 showing tuning results may cause the same light-emitting element to emit light. This case corresponds to states of (2), (4), and (5), and a light-emitting element showing tuning results is preferentially caused to emit light, as described referring to FIG. 9.

Further, the light-emitting element 82 showing a tempo and the light-emitting element 81 showing tuning results may cause the same light-emitting element to emit light, and that light-emitting element may be the one at the left end or the right end of the light-emitting element group l7. This case corresponds to the states of (1) and (7), and a light-emitting element showing a tempo is preferentially caused to emit light, as described referring to FIG. 9.

The display of a tempo is performed continuously by the light-emitting element group 17, which is a regular, periodic, and continuous display. Even if the omission of light emission occurs sometimes in one light-emitting element, an immediately adjacent light-emitting element emits light, so the notification of a tempo to a player is, hardly affected. However, the timing of the light-emission of a light-emitting element at the left end or the right end of the light-emitting element group 17 is frequently matched with the timing at which the tempo sound generating means generates a click sound. Therefore, the light-emitting element showing a tempo is preferentially caused to emit light at the timing where the light-emitting element at the left end or the right end of the light-emitting element group 17 is supposed to emit light, whereby the effect of causing a player to recognize a tempo exactly is prioritized.

Thus, the scale practice device 1 of Embodiment 3 can simultaneously display a tempo and tuning results to a player in such a manner that the player can easily identify each information, due to the mediation of the light-emission control information A and B by the mediation means. Further, the scale practice device 1 allows a player to recognize a tempo reliably at a timing of a click sound.

Embodiment 4

As Embodiment 4 of the present invention, still another operation of the scale practice device having a mode (simultaneous mode) for performing both a metronome mode and a tuning mode simultaneously will be described. An outer appearance of the scale practice device 1, an exemplary attachment thereof to a musical instrument, and a hardware configuration are the same as those described in Embodiment 1, so the description thereof will be omitted. Further, the basic functions are the same as that described in Embodiment 2, excluding the tempo display control means 34 and the mediation means 61, so the detailed description will be omitted.

In Embodiment 4, the tempo display control means 34 generates the light-emission control information A so as to display a tempo by causing light-emitting elements at both ends of the light-emitting element group 17 to emit light/extinguish light alternately.

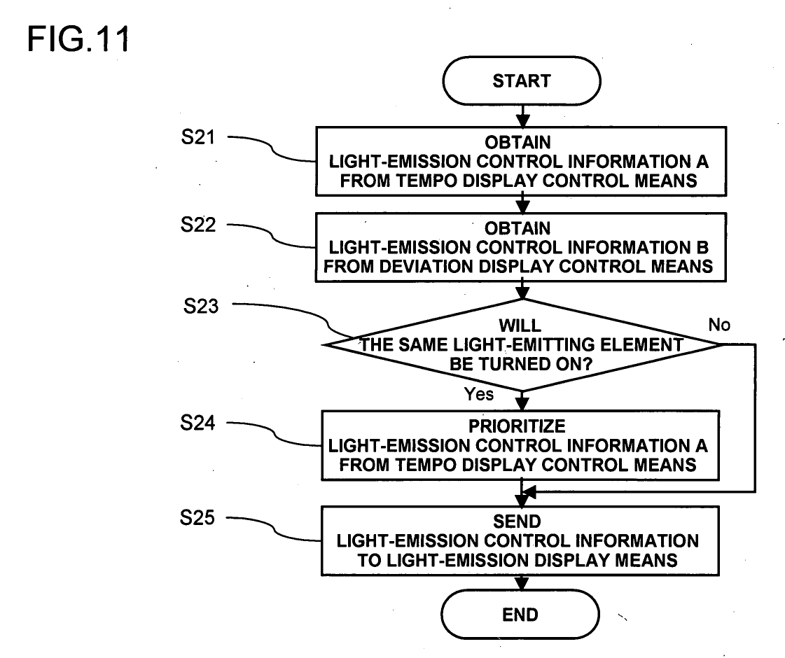

FIG. 11 is a flow chart showing a flow of the operation of the mediation means 61. First, the mediation means 61 obtains the light-emission control information A for displaying a tempo from the tempo display control means 34 (S21). The light-emission control information A includes identification information of a light-emitting element to emit light, information on a light-emission timing and a light-emission period, and the like.

Next, the light-emission control information B for displaying tuning results is obtained from the deviation display control means 40 (S22). The light-emission control information B also includes identification information on a light-emitting element to emit light, information on a light-emission timing and a light-emission period, and the like.

Next, it is confirmed whether or not the same light-emitting element should be caused to emit light at the same timing, based on the obtained light-emission control information, A and B (S23) In the case where the same light-emitting element is not caused to emit light at the same timing (No in S23), the light-emission control information A and B is sent to the light-emission display means 42 as light-emission control information from the mediation means 61 (S25), and the operation of the mediation means 61 is completed.

In the case where the same light-emitting element is caused to emit light at the same timing (Yes in S23), in order to display a tempo represented by the light-emission control information A preferentially, the light-emission control information B is deleted (S24). The prioritized light-emission control information A is sent from the mediation means 61 to the light-emission display means 42 as the light-emission control information (S25), and the operation of the mediation means 61 is completed.

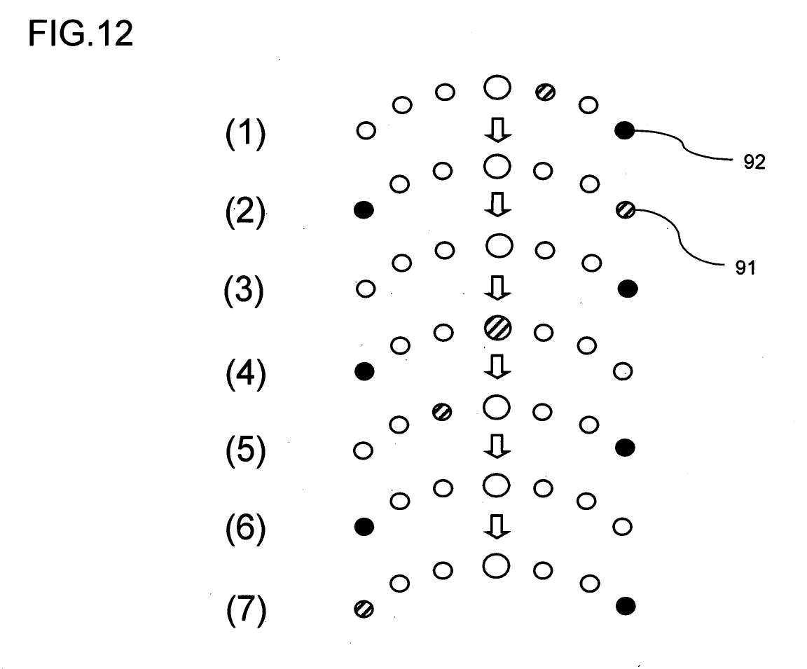

An example in which a light-emitting element of the light-emitting element group 17 emits light based on the light-emission control information sent from the mediation means 61 to the light-emission display means 42 will be described with reference to FIG. 12.

FIG. 12 schematically shows a light-emission method of the light-emitting element group 17 in the simultaneous mode. The states of (1) to (7) show a change in a light-emission state with the passage of time of the light-emitting element group 17. Shaded circles denoted by reference numeral 91 are light-emitting elements showing tuning results, and black circles denoted by reference numeral 92 are light-emitting elements showing a tempo. The light-emitting elements 91 and 92 may have the same color and the same brightness. The light-emitting elements 91 and 92 may also emit light with different colors, or may emit light with different brightness.

The light-emitting elements 92 showing a tempo are the light-emitting elements at both ends of the light-emitting element group 17, and repeat emitting light/extinguishing light alternately with the passage of time. The other light-emitting elements do not display a tempo, so they display only tuning results, whereby a display with very good visibility to a player can be performed.

Further, the light-emitting element 91 showing tuning results and the light-emitting element 92 showing a tempo may cause the same light-emitting element to emit light. This case corresponds to states of (3) and (6), and a light-emitting element showing a tempo is preferentially caused to emit light, as described referring to FIG. 11.

When the tempo to be displayed becomes faster, the light-emitting elements other than those at both ends of the light-emitting element group 17 emit light more frequently, in case where all the light-emitting elements of the light-emitting element group 17 are used to display a tempo. Then, the time period during which the light-emitting elements at both ends emit light in the display of a tempo becomes shorter, which may result in that a tempo is unlikely to be recognized. Therefore, as in Embodiment 4, a tempo is displayed only by the light-emitting elements at both ends, and the light-emission control information A and B is mediated, whereby a tempo and tuning results can be displayed simultaneously to a player so that the player can easily identify each information.

Embodiment 5

As Embodiment 5 of the present invention, still another operation of the scale practice device having a mode (i.e., simultaneous mode) for performing both a metronome mode and a tuning mode simultaneously will be described. An outer appearance, an exemplary attachment to a musical instrument, and a hardware configuration of the scale practice device 1 are the same as those described in Embodiment 1, so the description thereof will be omitted. Further, the basic functions are the same as that described in Embodiment 2, excluding the tempo display control means 34 and the mediation means 61, so the detailed description thereof will be omitted.

In Embodiment 5, the tempo display control means 34 generates the light-emission control information A so as to display a tempo by causing light-emitting elements at both ends of the light-emitting element group 17 to emit light/extinguish light alternately.

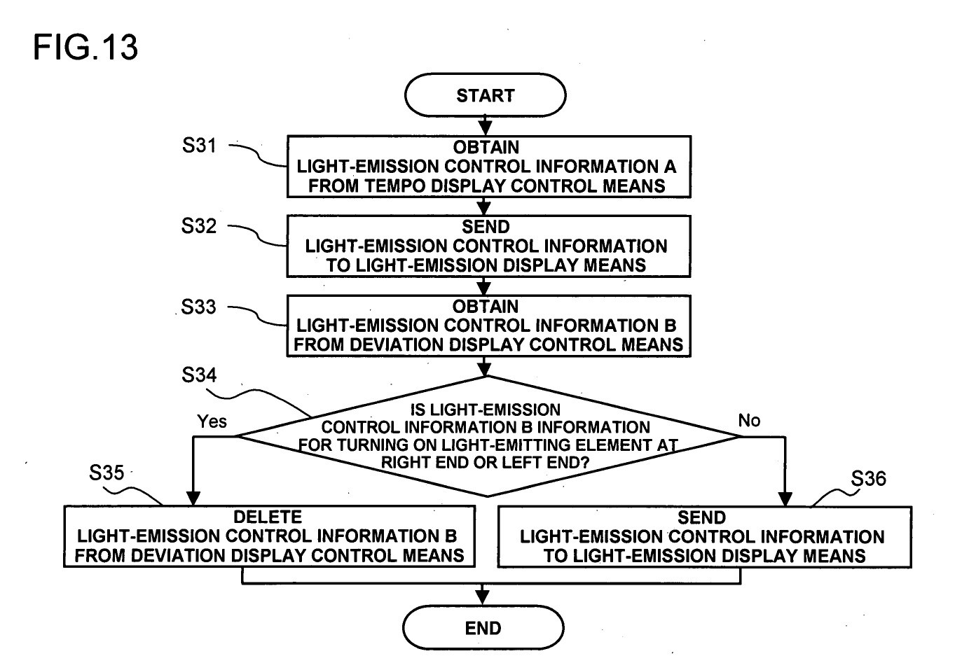

FIG. 13 is a flow chart showing a flow of the operation of the mediation means 61. First, the mediation means 61 obtains the light-emission control information A for displaying a tempo from the tempo display control means 34 (S31). The light-emission control information A includes identification information of a light-emitting element to emit light, information on a light-emission timing, a light-emission period, and the like.

Next, the obtained light-emission control information A is sent to the light-emission display means 42 as the light-emission control information from the mediation means 61 (S32). In Embodiment 5, any mediation is not performed regarding the display of a tempo.

Next, the light-emission control information B for displaying tuning results is obtained from the deviation display control means 40 (S33). The light-emission control information B also includes identification information on a light-emitting element to emit light, information on a light-emission timing, and a light-emission period, and the like.

Next, it is confirmed whether or not the obtained light-emission control information B is the information that causes a light-emitting element placed on either end (right end or left end) to emit light (S34).

In the case where the obtained light-emission control information B is not the information that causes a light-emitting element at the right or left end to emit light (No in S34), the light-emission control information A and B is sent to the light-emission display means 42 as light-emission control information from the mediation means 61 (S36), and the operation of the mediation means 61 is completed.

In the case where the obtained light-emission control information B is the information that causes a light-emitting element at the right or left end to emit light (Yes in S34), the light-emission control information B is deleted (S35), and the operation of the mediation means 61 is completed.

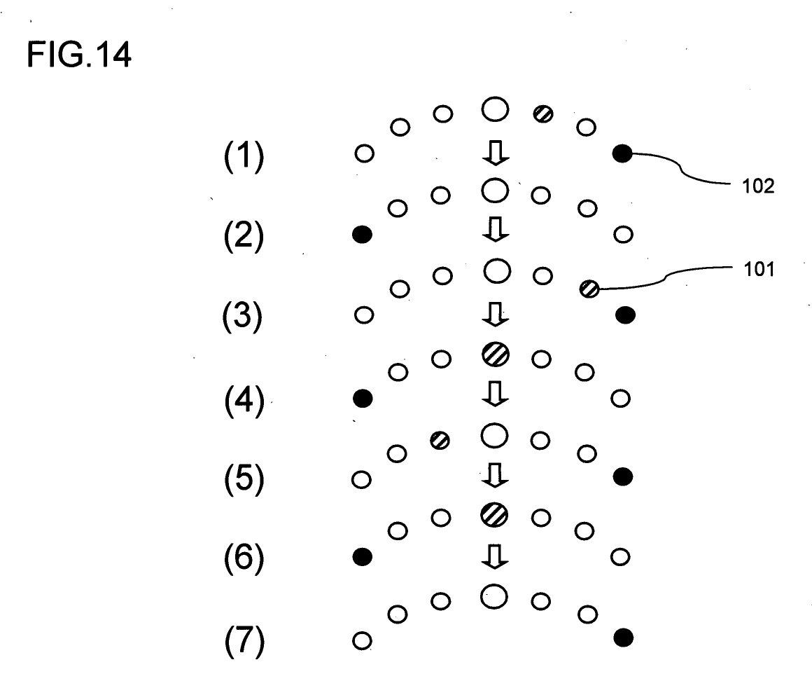

An example in which a light-emitting element of the light-emitting element group 17 emits light based on the light-emission control information sent from the mediation means 61 to the light-emission display means 42 will be described with reference to FIG. 14.

FIG. 14 schematically shows a light-emission method of the light-emitting element group 17 in the simultaneous mode. The states of (1) to (7) show a change in a light-emission state with the passage of time of the light-emitting element group 17. Shaded circles denoted by reference numeral 101 are light-emitting elements showing tuning results, and black circles denoted by reference numeral 102e are light-emitting elements showing a tempo. The light-emitting elements 101 and 102 may have the same color and the same brightness. The light-emitting elements 101 and 102 may also emit light with different colors, or may emit light with different brightness.

The light-emitting elements 102 showing a tempo are the light-emitting elements at both ends of the light-emitting element group 17, and repeat emitting light/extinguishing light alternately with the passage of time. The other light-emitting elements do not display a tempo, so that they display only tuning results, whereby a display with very good visibility to a player can be performed.

Further, the light-emission control information B representing tuning results may be the information that causes light-emitting elements at both ends of the light-emitting element group 17 to emit light. However, as described referring to FIG. 13, in that case, the light-emission control information B is deleted, and tuning results are not displayed. This case corresponds to states of (2) and (7).

When the tempo to be displayed becomes faster, the light-emitting elements other than those at both ends of the light-emitting element group 17 emit light more frequently, in case where all the light-emittig elements of the light-emitting element group 17 are used to display a tempo. Then, the time period during which the light-emitting elements at both ends emit light in the display of a tempo becomes shorter, which may result in that a tempo is unlikely to be recognized. Therefore, as in Embodiment 5, a tempo is displayed only by the light-emitting elements at both ends, and the both ends of the light-emitting element group 17 are assigned to merely display the tempo, whereby the tempo and the tuning results can be displayed simultaneously to a player so that the player can easily identify each information.

The tempo and the tuning results can be displayed using a, particular light-emitting element in the light-emitting element group 17 even without the mediation means 61. That is, control information can be generated by the tempo display control means 34 and the deviation display control means 40 so as to use a particular light-emitting element , and directly sent to the light-emission display means 42.

As described in Embodiments 1 to 5, the scale practice device of the present invention is directly attached to a musical instrument, using a musical instrument attachment portion such as a clip, so that tuning that is exact and highly responsive can be performed.

Further, the scale practice device of the present invention displays a tempo and tuning results, using the same light-emitting element group, so that the visibility is satisfactory even in a dark place, and a display space is saved. Consequently, the scale practice device of the present invention can be attached to a musical instrument, and is compact and excellent in portability.

In particular, the scale practice device of the present invention can simultaneously display a tempo and tuning results, using a light-emitting element group so that the tempo and the tuning results can be respectively identified with ease. Therefore, it is considered that the scale practice device of the present invention is the most suitable apparatus that supports the scale practice in which a tone from a musical instrument is generated at a constant pitch in time with a constant tempo sound, and the like.

An apparatus having both a metronome function and a tuning function can display both a tempo and tuning results simultaneously so that the tempo and the tuning results can be respectively identified with ease, by adopting a light-emission (display) method of a tempo and tuning results of the present invention. The display means in this case is not limited to a light-emitting element.

What is claimed is:

1. A scale practice device, comprising:
light-emission display means composed of a plurality of light-emitting elements placed in a row;
tempo setting means for setting a tempo, and generating an indication signal indicating a generation of a tempo sound in accordance with the tempo and a display of the tempo;
tempo display control means for generating tempo sound control information for controlling the generation of the tempo sound and tempo display control information for controlling the light emission of the light-emitting element of the light-emitting display means, based on the indication signal;
tempo sound generating means for generating a tempo sound based on the tempo sound control information;
vibration acquisition means for acquiring a tone generated by a musical instrument as a vibration, and converting the vibration into an electric signal;
input signal amplification means for amplifying a waveform of the electric signal;
waveform shaping means for shaping the waveform of the signal amplified by the input signal amplification means;
deviation detection means for calculating a fundamental frequency of the tone based on the signal with the waveform shaped by the waveform shaping means, and calculating a deviation between the fundamental frequency of the tone and a frequency of a reference sound;
deviation display control means for generating deviation display control information for controlling the light emission of the light-emitting element of the light-emission display means, based on the deviation; and
mediation means for obtaining the tempo display control information and the deviation display control information, and sending at least one of the tempo display control information and the deviation display control information to the light-emission display means, based on a predetermined condition,
wherein the light-emission display means displays the tempo and the deviation based on the information obtained from the mediation means.

2. A scale practice device according to claim 1, wherein the tempo display control means generates tempo display control information for controlling the light emission of the light-emitting element of the light-emission display means, based on the indication signal, so that the tempo is displayed by causing light-emitting elements to sequentially emit light and sequentially extinguish light from one end to another end of the light-emission display means.

3. A scale practice device according to claim 2, wherein in a case where the tempo display control information and the deviation display control information are not information for causing the same light-emitting element to emit light at a same timing, the mediation means sends the tempo display control information and the deviation display control information to the light-emitting display means.

4. A scale practice device according to claim 2, wherein in a case where the tempo display control information and the deviation display control information are information for causing the same light-emitting element to emit light at a same timing, the mediation means sends only the deviation display control information to the light-emission display means.

5. A scale practice device according to claim 4, wherein in a case where the tempo display control information and the deviation display control information are information for causing the same light-emitting element to emit light at a same timing, and in a case where a light-emitting element to emit light is placed at one of ends of a row of the light-emission display means, the mediation means sends only the tempo display control information to the light-emission display means.

6. A scale practice device according to claim 1, wherein the tempo display control means generates tempo display control information for controlling the light emission of the light-emitting element of the light-emission display means based on the indication signal so that the tempo is displayed by causing light-emitting elements at both ends of the light-emission display means to emit light and extinguish light alternately.

7. A scale practice device according to claim 6, wherein in a case where the tempo display control information and the deviation display control information are not information for causing a same light-emitting element to emit light at a same timing, the mediation means sends the tempo display control information and the deviation display control information to the light-emitting display means.

8. A scale practice device according to claim 6, wherein in a case where the tempo display control information and the deviation display control information are information for causing the same light-emitting element to emit light at the same timing, the mediation means sends only the tempo display control information to the light-emission display means.

9. A scale practice device according to claim 6, wherein in a case where the deviation display control information is information for causing a light-emitting element at one of the ends of the light-emission display means to emit light, the mediation means stops sending the deviation display control information to the light-emission display means.

10. A scale practice device according to claim 1, wherein the light-emitting element of the light-emission display means is capable of emitting light of multi-color, and displays the tempo and the deviation with different colors.

11. A scale practice device according to claim 1, wherein the light-emitting element of the light-emission display means is capable of controlling the brightness, and displays the tempo and the deviation with different brightness.

12. A scale practice device according to claim 1,
further comprising instrument attachment means for fixing a body of the scale practice device to the musical instrument,
wherein the vibration acquisition means acquires a vibration generated when the musical instrument generates a tone from the musical instrument via the musical instrument attachment means.

13. A scale practice device for supporting a scale practice of a musical instrument, comprising:
instrument attachment means for fixing the scale practice device to the musical instrument;
light-emission display means composed of a plurality of light-emitting elements placed in a row;
tempo setting means for setting a tempo, and generating an indication signal indicating a generation of a tempo sound in accordance with the tempo and a display of the tempo;
tempo display control means for generating tempo sound control information for controlling the generation of the tempo sound and tempo display control information for controlling the light emission of the light-emitting element of the light-emitting display means, based on the indication signal;
tempo sound generating means for generating a tempo sound based on the tempo sound control information;
vibration acquisition means for acquiring a tone generated by the musical instrument as a vibration from the musical instrument via the musical instrument attachment means, and converting the vibration into an electric signal;
input signal amplification means for amplifying a waveform of the electric signal;
waveform shaping means for shaping the waveform of the signal amplified by the input signal amplification means;
deviation detection means for calculating a fundamental frequency of the tone based on the signal with the waveform shaped by the waveform shaping means, and calculating a deviation between the fundamental frequency of the tone and a frequency of a reference sound; and
deviation display control means for generating deviation display control information for controlling the light emission of the light-emitting element of the light-emission display means, based on the deviation,
wherein the light-emission display means obtains at least one of the tempo display control information and the deviation display control information, and displays at least one of the tempo and the deviation.

14. A scale practice device according to claim 13, wherein the tempo display control means generates tempo display control information for controlling the light emission of the light-emitting element of the light-emission display means, based on the indication signal, so that the tempo is displayed by causing light-emitting elements to sequentially emit light and sequentially extinguish light from one end to another end of the light-emission display means.

15. A scale practice device according to claim 13, wherein:
the tempo display control means generates tempo display control information for controlling the light emission of the light-emitting element of the light-emission display means based on the indication signal so that the tempo is displayed by causing at least one particular light-emitting element of the light-emission display means to emit light and extinguish light; and
the deviation display control means generates deviation display control information for controlling the light emission of the light-emitting element based on the deviation so that the deviation is displayed using a light-emitting element other than the at least one particular light-emitting element of the light-emission display means.

16. A scale practice device according to claim 15, wherein the at least one particular light-emitting element is placed at both ends of the light-emission display means.
